(19) United States
(12) Patent Application Publication
(10) Pub. No.: US 2022/0056879 A1
(43) Pub. Date: Feb. 24, 2022

(54) Self-Contained Hydroelectric Grid Power System

(71) Applicant: Terry A. Maiers, Badin, NC (US)

(72) Inventor: Terry A. Maiers, Badin, NC (US)

(21) Appl. No.: 17/000,296

(22) Filed: Aug. 22, 2020

(51) Int. Cl. F03B 13/06; H02S 10/10

(52) U.S. Cl. CPC F03B 13/06; H02S 10/10

(57) ABSTRACT

In today's world, 33 billion tons of co2 generating electrical energy from burning fossil fuels (World Nuclear Association, May 2021) to heat water to steam to drive the turbines. The invention in this document is designed specifically to convert the existing fossil fuel burning electrical generation systems to a non-fossil, renewable generation system. This would be accomplished utilizing off-the-shelf, existing technologies in a new configuration. The configuration utilizes solar collection systems (1), energy storage system (2), liquid water, wet/dry water pump (3), water storage system (6) equipment and water driven turbine (4), the various components are connected to work together and attached to existing generation turbine (5) as the replacement for the fossil fuel systems.

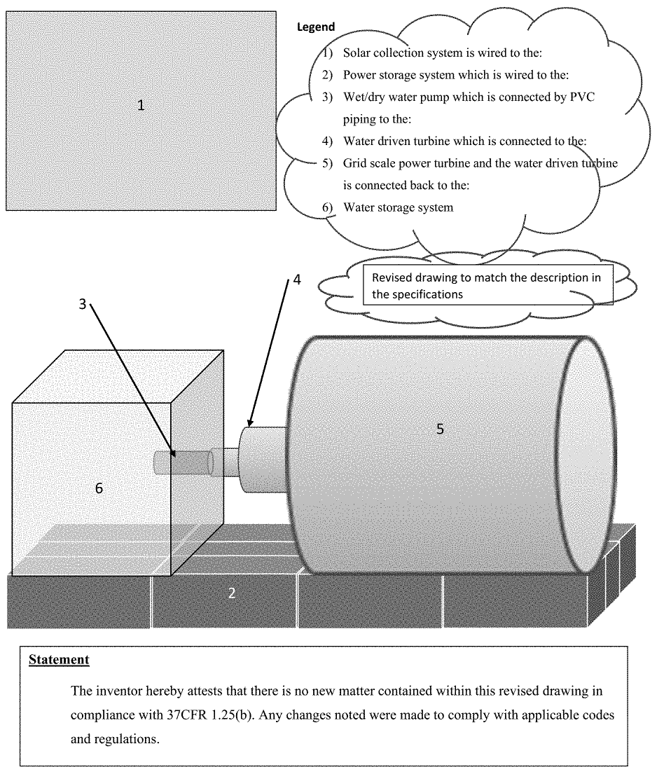

Citations

Staff, Carbon Dioxide Emission from Electricity, World Nuclear Association, May 2021, Retrieved from: https://www.world-nuclear.org/information-library/energy-and-the-environment/carbon-dioxide-emissions-from-electricity.aspx

### CROSS-REFERENCE TO RELATED APPLICATIONS

| ID | USPTO Document # | Date | Inventor | CPC Class | US Class |
|---|---|---|---|---|---|
| A | US-10280893-B2 | May 2019 | Jessamy, Frederick J. | F03B13/086 | 1/1 |
| B | US-20090271336-A1 | October 2009 | Franks, Travis Dean | H02J3/008 | 705/500 |
| C | US-20140175799-A1 | June 2014 | Tabe, Joseph Akwo | F03D9/00 | 290/55 |
| D | US-20160111918-Al | April 2016 | Benson, Mark Edwin | B60L53/53 | 307/23 |
| E | US-20160241029-A1 | August 2016 | Hodrinsky, Todd W. | H02J7/0072 | 1/1 |
| F | US-9825461-B2 | November 2017 | Hodrinsky, Todd W. | H02J7/0072 | 1/1 |
| G | US-20160348637-Al | December 2016 | Bachli, Emil | F03B17/005 | 1/1 |
| H | US-11067099-B2 | July 2021 | Bachli, Emil | F03D9/17 | 1/1 |
| I | US-20140327247-A1 | November 2014 | Calabro, David | F03D9/11 | 290/4C |
| J | US-9683539-B2 | June 2017 | Calabro, David | F03D3/002 | 1/1 |
| K | US-20170292500-A1 | October 2017 | Calabro, David | F03D9/008 | 1/1 |
| L | US-20200341439-A1 | October 2020 | Valin, David | H02s10/20 | 1/1 |
| M | US-6718761-B2 | 94/2004 | Merswolke, Paul H.F. | F03D9/25 | 60/398 |
| N | US-4358250-A | November 1982 | Payne, Barrett M. M. | F04B9/1273 | 417/302 |
| O | US-4206608-A | June 1980 | Bell, Thomas J. | F03D9/28 | 60/698 |
| P | US-4055950-A | November 1977 | Grossman, William C. | F03d9/10 | 60/398 |
| Q | US-9347436-B2 | May 2016 | Iwanowski, Darlusz Krzysztof | F03D9/11 | 1/1 |
| R | US-8878381-B2 | November 2014 | Henry, Terry Wayne | F03D9/008 | 290/53 |
| S | US-8312733-B2 | November 2012 | Tsarev, Viktor V. | F03D9/25 | 62/238.3 |
| T | US-8096293-B2 | 91/2012 | Hoellenriegel, Wolfgang | F24D11/0221 | 126/617 |
| U | US-7555897-B2 | July 2009 | Alekseevich, Alexander N. | F03D9/25 | 60/398 |
| V | US-4079591-A | March 1978 | Derby, Ronald C. | F24520/20 | 60/641.8 |
| W | US-4031702-A | June 1977 | Burnett, James T. | F03D9/007 | 60/398 |

Note: The above data was provided by the USPTO and titled as “Noted References Cited”, the Inventor is providing a summary of the art associated with this data based on a search of the Internet.

### STATEMENT REGARDING FEDERALLY SPONSORED RESEARCH OR DEVELOPMENT

The inventor hereby states that no part of the research and development of the application for patent for this invention was sponsored by or funded by any federal agency.

### THE NAMES OF THE PARTIES TO A JOINT RESEARCH AGREEMENT

Not applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable

### STATEMENT REGARDING PRIOR DISCLOSURES BY THE INVENTOR OR A JOINT INVENTOR

To the best knowledge of the inventor, there has been no prior disclosure of the contents of the materials related to this application prior to the date of the submission of the application.

### BACKGROUND OF THE INVENTION

1) The background of the invention is related directly to the generation of electrical energy by the utilization of the kinetic energy in moving water at the grid scale.

2) Description of related art (the data below is based on a summary of the various data in section (b) above as provided by “Google Patents” web site)

| | USPTO Document | Description Summary |
|---|---|---|
| A | US-10280893-B2 | The art is for a vacuum system that causes the |
| | | water to fall using gravity on a ramp system to |
| | | turn the turbine to generate the electrical energy |
| B | US-20090271336-A1 | The art is for the development of a system of |
| | | power generation utilizing human power to |
| | | generate the energy by human use of fitness |
| | | equipment in a fitness center |
| C | US-20140175799-A1 | The art is for the use of wind and hydro systems |
| | | to be compressed to a certain point and released |
| | | in an unspecified mechanism to turn the |
| | | generation turbine |
| D | US-20160111918-A1 | The are is for a system of power storage and |
| | | activation for domestic and residential uses |
| | | utilizing batteries or other storage system |
| E | US-20160241029-Al | The art is for a direct current power system |
| | | across a distribution network |
| F | US-9825461-B2 | The art is similar in nature to the direct power |
| | | distribution system as noted in the system in E |
| | | above |
| G | US-20160348637-Al | The art is for a system of pumped water utilized |
| | | to raise the pressure of an unspecified gas within |
| | | a sealed system which then turns the turbine to |
| | | generate the electrical energy |
| H | US-11067099-B2 | The art is for a method and system for combining |
| | | pumped water pressure to compress air for stored |
| | | energy at a constant water pressure |
| I | US-20140327247-Al | The art is a system of interchangeable |
| | | components utilizing wind, solar, hydraulic and |
| | | mechanical devices to rotate a rotor for |
| | | generating the electrical energy |
| J | US-9683539-B2 | The art is a system of interchangeable |
| | | components utilizing wind, solar, hydraulic and |
| | | mechanical devices to rotate a rotor for |
| | | generating the electrical energy |
| K | US-20170292500-Al | The art is a system of interchangeable |
| | | components utilizing wind, solar, hydraulic and |
| | | mechanical devices to rotate a rotor for |
| | | generating the electrical energy |
| L | US-20200341439-Al | The art is for a system of solar panels and a |
| | | hydraulic pumping system that pumps the water |
| | | uphill to allow gravity to move the water |
| | | downhill at a greater rate of speed to provide |
| | | additional energy to enhance and supplement the |
| | | solar energy panels |
| M | US-6718761-B2 | The art if for a series of windmills connected to |
| | | compressed air generators that produce the |
| | | compressed air which is used to force the water |
| | | through a turbine to generate the electrical |
| | | energy |
| N | US-4358250-A | The art is for a wind capture system connected to |
| | | air compressors that a cylinder that contains a |
| | | piston which is moved by the compressed air to |
| | | generate the energy |
| O | US-4206608-A | The are is for a system of pressurized hydraulic |
| | | fluid within a sealed system of high-pressure |
| | | storage tanks for use and recovery for later use |
| | | by repressurizing the fluid utilizing excess |
| | | electrical energy |
| P | US-4055950-A | The art is a system of windmills connected to air |
| | | compressors to compress that air that is stored in |
| | | high-pressure storage tanks that is then used to |
| | | move an unspecified hydraulic fluid which will |
| | | generate the electrical energy by being connected |
| | | to a generator |
| Q | US-9347436-B2 | The art is a system of utilizing a portion of the |
| | | electrical energy created by a generator to heat |
| | | an unspecified liquid to increase the pressure in |
| | | the storage tank while using a heat exchanger to |
| | | extract the heated material to turn a turbine to |
| | | generate the electrical energy |
| R | US-8878381-B2 | The art is for a device that is designed to convert |
| | | the motion of wave action into electrical energy |
| | | by means of hydraulic cylinders that move with |
| | | the motion of the waves creating a rotational |
| | | effect to turn the motor |
| S | US-8312733-B2 | The art if for a system of windmills for electrical |
| | | energy and solar panels to the collection of heat |
| | | that would be used in conjunction with the wind |
| | | energy for heat and electricity |
| T | US-8096293-B2 | The art is for a solar energy system to provide |
| | | the means of generating hot water by using a |
| | | geothermal heat exchanger and various other |
| | | mechanisms for storing the heated water |
| U | US-7555897-B2 | The art is for a system of wind and solar system |
| | | to generate electrical energy and heat supplies |
| | | for living and industrial uses |
| V | US-4079591-A | The art is described as a solar power plant which |
| | | utilizes an array of solar tracking collectors and |
| | | conversion devices to generate electrical energy |
| | | as well as using specific heat exchangers to heat |
| | | a liquid to a superheated gas |
| W | US-4031702-A | The art is for the use of wind and solar power or |
| | | water movement to power a hydraulic pump |
| | | which pumps the fluid into a storage tank at a |
| | | constant pressure and then used to activate a |
| | | hydraulic motor |

The prior art as supplied by the USPTO and summarized above, while utilizing some of the same components, do not connect and utilize the components in the same manner as this invention.

### A SUMMARY OF THE INVENTION

The invention is a system that is comprised of existing, off-the-shelf components. The invention is designed to provide the means of converting fossil fuel (coal, oil, natural gas) powered electrical generation systems on a grid scale, to a “green”, non-polluting power system that does not require the use if a heated water to generate the force require to turn the turbine and generate electricity. This will be accomplished by utilizing the energy supply company's existing infrastructure of solar panels along with the new equipment (low voltage water pump, water storage tank and impeller system) and existing battery storage capabilities.

### BRIEF DESCRIPTION OF THE DRAWING

The drawing is diagrammatic and is intended to show how the essential components are intended to be assembled.

### DETAILED DESCRIPTION OF THE INVENTION

The invention is comprised of the following components and operational connections in sequence:

1) Solar collection system is wired to the:

2) Power storage system which is wired to the:

3) Wet/dry water pump which is connected by PVC piping to the:

4) Water driven turbine which is connected to the:

5) Grid scale power turbine and the water driven turbine is connected back to the:

6) Water storage system

The components and connections noted above are the general concepts of the invention and its operation for converting existing fossil fuel generation systems. However, it needs to be noted that the specific size of the individual components will vary depending on the application for which the system will be used. Additionally, the system is designed to be used as a stand-alone operation for a single turbine but can be scaled up to connect multiple turbines in sequence.

A couple of examples of how the invention could be used for differing types and sizes of generation systems. A typical commercial electrical generation turbine rotates at a speed of 1,800 RPM's. This rotation as caused by pressurized steam that is rated at +/−25psia, thus the water pump designed for the invention for that application would be capable of providing that same pressure for the turbine to reach the required 1,800RPM's.

Another application for which this system could be installed would be for the replacement of a large hydroelectrical dam system. This would be possible because the system is designed to be self-contained thus there would not be any water loss. In the same manner as the required engineering for sizing the components, the Hoover Dam for example has turbines that rotate as a mere 18ORPM's and a water speed of 85 MPH or 1.42 miles per minute. Additionally, for this type of application and the commercial generation system, the quantity of water and the piping sizes would require engineering to optimize the systems for the individual application.

### STATEMENT

The inventor hereby attests that there is no new matter contained within this revised specification in compliance with 37 CFR 1.25(b). Any changes noted were made to comply with applicable codes and regulations.

1) The invention is a self-contained hydroelectrical grid system. The object of the invention is to replace or convert existing electrical power grid power systems from fossil fuel fired power to a renewable or “green” environmentally friendly power system. The system is comprised of the following components:
1) Solar collection system
2) Power storage system
3) Wet/dry water pump
4) Water driven turbine
5) Grid scale power turbine
6) Water storage system
The components are design in a configuration to provide the means of rotating the shaft of the power grid turbine at the required rotational speed to optimize the electrical energy production. Additionally, the system is designed to be scalable to provide operational power to a wide variety of grid level power generation systems.
